(19) United States
(12) Patent Application Publication
(10) Pub. No.: US 2002/0186721 A1
(43) Pub. Date: Dec. 12, 2002

(54) Methods and systems for monitoring traffic received from and loading simulated traffic on broadband communication link

(76) Inventor: David Weaver Bohn, Raleigh, NC (US)

Correspondence Address: JENKINS & WILSON, PA, 3100 TOWER BLVD, SUITE 1400, DURHAM, NC, 27707, US

(21) Appl. No.: 09/802,688

(22) Filed: Mar. 9, 2001

(51) Int. Cl. H04L 1/00; G06F 11/00

(52) U.S. Cl. 370/522; 370/235

(57) ABSTRACT

Methods and systems for loading and receiving traffic from a broadband communication link, such as an OC-3, link are disclosed. A system for loading a broadband communication link includes a simulated traffic generator for generating simulated traffic to be sent over the broadband communication link. Cascadable processing modules receive and aggregate the simulated traffic to load a broadband communication link. The cascadable processing modules can also receive and process data from a broadband communication link. Each cascadable processing module filters and processes a portion of received traffic. A single platform can be configured to simultaneously load a broadband communication link and receive traffic from the broadband communication link.

### TECHNICAL FIELD

The present invention relates to methods and systems for monitoring traffic received from and loading simulated traffic on a broadband communication link. More particularly, the present invention relates to methods and systems for transmitting and receiving traffic over a broadband communication link using a plurality of cascadable processing modules.

### BACKGROUND ART

Conventional network monitoring and traffic simulation devices are designed to test low speed signaling links, such as 64 kbps SS7 signaling links. On the transmit side, such devices typically include the processing capability to load an SS7 signaling link with simulated signaling traffic. On the receive side, such devices can receive and process signaling data from a device under test, such as an SS7 signaling point, at the SS7 signaling rate of 64 kbps.

With the advent of fiber optic communications, data rates higher than those of conventional SS7 signaling links can be achieved. For example, synchronous optical network (SONET) and synchronous digital hierarchy (SDH) are physical layer transmission protocols that are capable of bit rates of on the order of megabits or even gigabits per second. The initial proposal for SONET developed in the early 1980s had a bit rate of 50.688 Mbps, a 125 uS frame, and a frame format of 3 rows by 265 columns (264 octets*3 rows*8 bits per octet/125 uSec=50,688,000). After various modifications to the initial SONET proposal, a base rate of 51.84 Mbps was chosen as the North American standard and 155.52 Mbps was chosen as the base rate for the European standard (51.84 Mbits/s*3).

In a SONET network, user signals, such as T1, E1, and ATM cells are converted into a standard format called the synchronous transport signal (STS), which is the basic building block of the SONET multiplexing hierarchy. The STS signal is an electrical signal. The notation STS-n refers to integer multiples of the base 51.84 Mbps signal. For example, STS-1 refers to 1*51.84 Mbps, STS-3 refers to 51.84*3=155.52 Mbps, etc.

STS signals are converted to optical signals that are referred to in North America as optical carrier (OC) signals. The notation OC-n indicates the number of base rate STS signals that are multiplexed in a given optical data stream. For example, OC-3 refers to a stream of three multiplexed STS signals or 155.52 Mbps. The basic transmission unit for SONET is the STS-1 synchronous payload envelope. SDH starts with STS-3. Table 1 shown below illustrates below illustrates the SONET signaling hierarchy.

TABLE 1
SONET Signal Hierarchy

| OC Level | STS Level | Line Rate (Mbits/s) |
|---|---|---|
| OC-1 | STS-1 | 51.840 Mbits/s |
| OC-3 | STS-1 | 155.520 Mbits/s |
| OC-9 | STS-3 | 466.560 Mbits/s |
| OC-12 | STS-9 | 622.080 Mbits/s |
| OC-18 | STS-12 | 933.120 Mbits/s |
| OC-24 | STS-24 | 1244.160 Mbits/s |
| OC-36 | STS-36 | 1866.230 Mbits/s |
| OC-48 | STS-48 | 2488.32 Mbits/s |
| OC-96 | STS-96 | 4876.64 Mbits/s |
| OC-192 | STS-192 | 9953.28 Mbits/s |

From Table 1, it can be seen that in OC transmission systems, data streams consists of n multiplexed STS signals, where n equals 1, 3, 9, 12, 18, 24, 36, 48, and 192. It is envisioned that multiplexing integrals of STS signals greater than 192 will be incorporated into the standard in the future.

In order to test devices that operate at SONET and SDH data rates, it is necessary to generate simulated traffic streams at these data rates. In addition, in order to monitor traffic produced by such devices, it is necessary to receive and process data at these high data rates. As stated above, conventional telephony network monitoring devices are incapable of generating or monitoring data at broadband data rates, such as OC-n data rates. Accordingly, there exists a need for methods and systems for generating simulated traffic at broadband data rates and monitoring traffic at broadband data rates.

### DISCLOSURE OF THE INVENTION

A method for loading a broadband communication link, such as an OC-3 link, with simulated message traffic using a plurality of cascadable processing modules is disclosed. As used herein, the term “communication link” refers to communication links that can carry signaling traffic, data or user traffic, or any combination thereof. The cascadable processing modules are connected in series or cascaded. Each of the cascadable processing modules generates a portion of the simulated message traffic to be sent over the broadband communication link and forwards the simulated signaling or data traffic to the next cascadable processing module. The portion of simulated signaling or traffic generated by the first cascadable processing module is followed by an idle portion. While the first cascadable processing module is generating its simulated signaling or data traffic, the remaining cascadable processing modules are simultaneously generating their own simulated signaling or data traffic to load the broadband communication link. Subsequent cascadable processing modules receive the simulated signaling or data traffic from upstream cascadable processing modules, detect the idle portions in the traffic stream, and replace the idle portions of the traffic with their own signaling traffic. The last cascadable processing module receives the aggregated simulated signaling or data traffic from the upstream modules and sends the simulated signaling or data traffic over a broadband communication link. Because the present invention utilizes the distributed processing power of cascadable processing modules to load a broadband link, each individual processing module need not have sufficient processing capacity to load the broadband link alone. As a result, simulated traffic generation systems can be designed using inexpensive, general-purpose processors and scaled to the needs of a particular traffic simulation.

In the receive direction, a first cascadable processing module in a traffic monitoring device receives signaling or bearer data from a broadband communication link, such as an OC-3 link. The first cascadable processing module applies one or more filters to the incoming data and extracts a portion of the traffic for further processing and forwards the remainder of the traffic to downstream modules. Each cascadable processing module is configured to filter a different portion of the incoming broadband traffic and forward the remainder to downstream processing modules. Because each cascadable module is only responsible for a predetermined portion of the traffic, a broadband data stream can be monitored without utilizing specialized high-speed processors.

A platform according to an embodiment of the present invention is capable of simultaneously sending simulated traffic to and receiving traffic from a broadband communication link. Simulated traffic to be transmitted to a device under test and traffic received from the device under test traverses the same path through the cascadable processing modules of the platform. The cascadable processing modules each filter and process a portion of the data being monitored. The cascadable processing modules also each produce a portion of the traffic to be sent over a broadband communication link. Such simultaneous transmitting and processing capability enables full testing of broadband communication devices, such as ATM switches and ATM-based SS7 signaling points.

Accordingly, it is an object of the invention to load a broadband communication link with simulated signaling traffic without utilizing specialized high-speed processing units.

It is another object of the invention to process data received over a broadband communication link from a device under test without utilizing specialized high speed processing units.

Some of the objects of the invention having been stated hereinabove, other objects will become evident as the description proceeds when taken in connection with the accompanying drawings as best described hereinbelow.

### BRIEF DESCRIPTION OF THE DRAWINGS

A description of preferred embodiments will now proceed with reference to the accompanying drawings, of which:

FIG. 1 is a block diagram of a plurality of cascadable processing modules connected in series for loading a broadband communication link according to an embodiment of the present invention;

FIG. 2 is a block diagram of a plurality of cascadable processing modules connected in series for receiving data from a broadband communication link according to an embodiment of the present invention;

FIG. 3 is a block illustrating transmit functionality of a plurality of cascadable processing modules according to an embodiment of the present invention;

FIG. 4 is a timing diagram illustrating an exemplary bandwidth allocation algorithm associated with a cascadable processing module for loading a broadband communication link according to an embodiment of the present invention;

FIG. 5 is a block diagram illustrating receive functionality of a plurality of cascadable processing modules according to an embodiment of the present invention;

FIG. 6 is a block diagram illustrating exemplary hardware associated with a link interface module (LIM) of a cascadable processing module according to an embodiment of the present invention; and

FIG. 7 is a block diagram of a platform including a plurality of cascadable processing modules configured to send simulated traffic to and receive traffic from a broadband communication link according to an embodiment of the present invention.

### DETAILED DESCRIPTION OF THE INVENTION

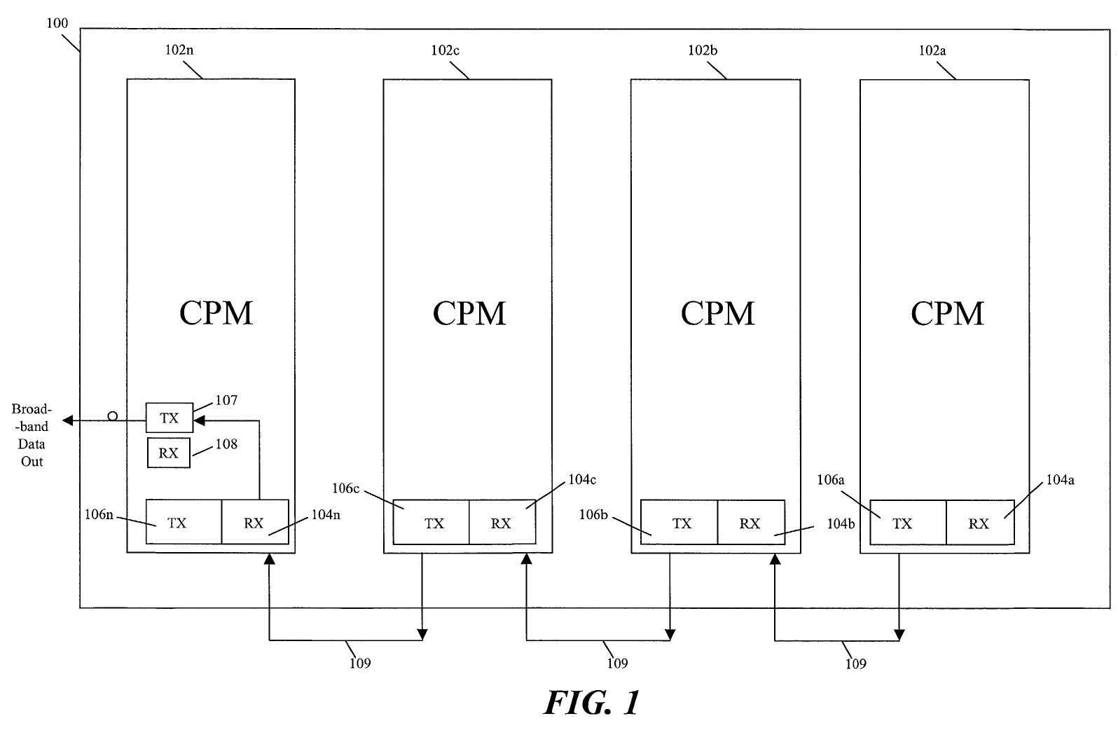

FIG. 1 is a functional block diagram of the platform including a plurality of cascadable processing modules suitable for loading a broadband communication link and for processing data received from a broadband communication link according to an embodiment of the present invention. In FIG. 1, platform 100 includes a plurality of cascadable processing modules (CPMs) 102a-102n. Each of the cascadable processing modules 102a-102n includes circuitry, such as microprocessors, field programmable gate arrays (FPGAs), and/or application specific integrated circuits (ASICs) for generating a portion of simulated signaling or data traffic to fill a broadband communication link and for processing a portion of signaling or data traffic received from a broadband signaling length. In the illustrated embodiment, each of the cascadable processing modules 102a-102n respectively includes external receive interfaces 104a-104n and external transmit interfaces 106a-106n. External receive interfaces 104a-104n of cascadable processing modules 102a-102n are capable of receiving traffic being monitored from an external physical communication link, such as an optical or electrical link. External transmit interfaces 106a-106n are capable of transmitting simulated signaling or data traffic over an external communication link, such as an optical or electrical link.

At least one of the cascadable processing modules 102a-102n preferably includes broadband transmit and receive interfaces for sending and receiving data over a broadband communication link. In the illustrated embodiment, cascadable processing module 102n includes a broadband transmit interface 107 and a broadband receive interface 108 for sending and receiving data over a broadband communication link, such as an OC-n communication link.

In order to reduce the need for specialized high-speed processors, cascadable processing modules 102a-102n are preferably connected in series or cascaded. When transmitting data over a broadband communication link, simulated signaling or data traffic from each cascadable processing module 102a-102n can be aggregated. When receiving data from a broadband communication link, a portion of the received data can be processed by each cascadable processing module and the remainder can be passed to downstream processing modules to be processed.

In the illustrated embodiment, external transmit interfaces 106a-106c of cascadable processing modules 102a-102c are connected to external receive interfaces 104b-104n of cascadable processing modules 102b-102n via external serial communication links 109. External receive interface 104n of cascadable processing module 102n is connected to broadband external transmit interface 107. Connecting the external transmit interfaces of each cascadable processing module to the external receive interface of its immediately downstream cascadable processing module allows the aggregation of simulated signaling or data traffic generated by cascadable processing modules 102a-102n. However, the present invention is not limited to utilizing external serial communication links 109 to connect cascadable processing modules 102a-102n. In an alternate embodiment of the invention, simulated outgoing message traffic and incoming monitored traffic may be distributed among cascadable processing modules 102a-102n via an internal serial communications link or links.

In operation, in order to fill or fully load a broadband communication link, each cascadable processing module 102a-102n generates a portion of the simulated signaling or data traffic to be sent over the broadband communication link. For example, in the illustrated embodiment, platform 100 includes four CPMs, so each CPM may generate 25% of the traffic required to fill the broadband communication link. CPM 102a may forward its 25% of the simulated traffic followed by an idle traffic portion to CPM 102b through interfaces 106a and 104b. The speed of serial links 109 that interconnect CPMs 102a-102n is preferably at least as fast as the outbound broadband communication link connected to interface 107. Thus, continuing with the example above where each CPM generates 25% of the traffic, link 109 between CPMs 102a and 102b would contain 25% simulated traffic and 75% idle traffic.

CPM 102b receives the simulated traffic portion and the idle traffic portion from CPM 102a. CPM 102b detects the idle traffic portion and replaces part of the idle traffic portion with its simulated traffic. CPM 102b then forwards the simulated traffic and the idle traffic to CPM 102c. Thus, continuing with the example, link 109 between CPMs 102b and 102c contains 50% simulated traffic and 50% idle traffic.

CPM 102c receives the simulated traffic portion and the idle traffic portion from CPM 102b. CPM 102c detects the idle traffic portion and replaces part of the idle traffic portion with its simulated traffic. CPM 102c then forwards the simulated traffic and the idle traffic to CPM 102n. Thus, continuing with the example, link 109 between CPMs 102c and 102n contains 75% simulated traffic and 25% idle traffic.

CPM 102n receives the simulated traffic portion and the idle traffic portion from CPM 102c. CPM 102n detects the idle traffic portion and replaces part of the idle traffic portion with its simulated traffic. CPM 102n then forwards the simulated traffic over the external broadband communication link through interface 107. The broadband communication link is 100% loaded with simulated signaling traffic. Thus, by utilizing cascadable processing modules 102a-102n, a broadband communication link can be fully loaded without requiring specialized high-speed processors. Cascadable processing modules 102a-102n effectively function as a distributed multiplexer to fill the broadband communication link. Each cascadable processing module may include a general-purpose processor for generating the required simulated signaling traffic.

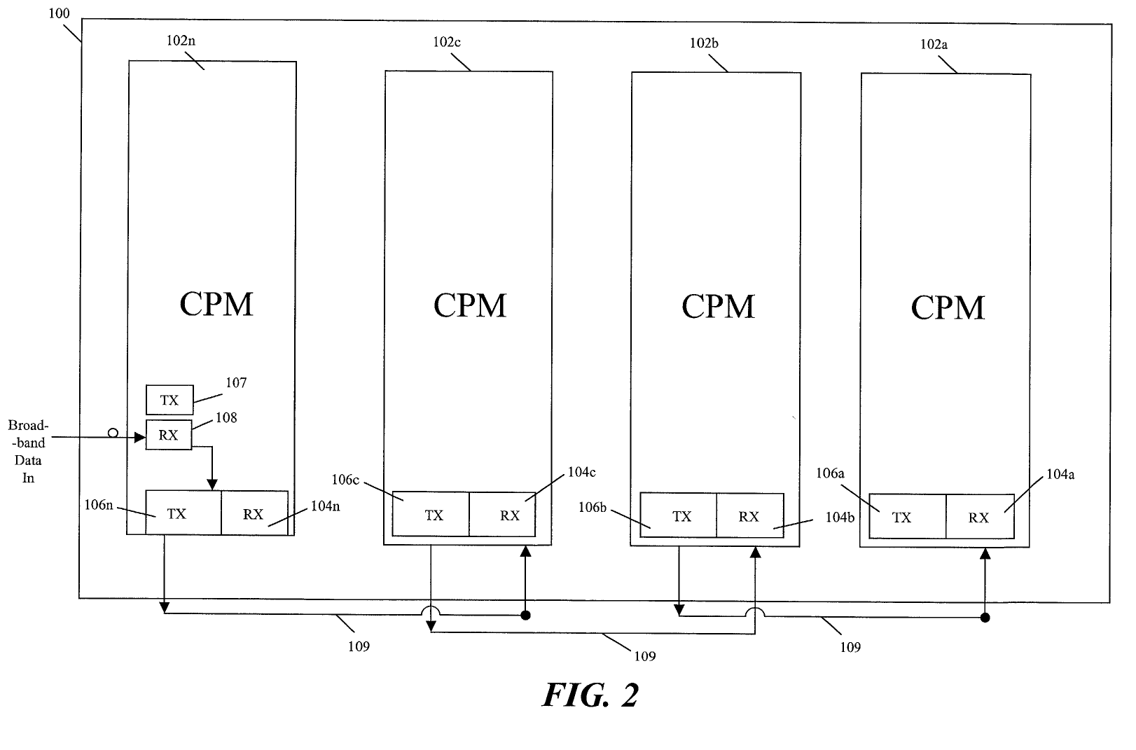

FIG. 2 illustrates and example of platform 100 wherein CPMs 102a-102n are connected in series to process monitored data received via a high speed optical link connected to external broadband receive interface 108 of CPM 102n. In addition, each CPM 102a-102n is preferably also configured, either in hardware or software, to process a predetermined portion of incoming broadband data being monitored and to forward the remainder to downstream processors. For example, external broadband receive interface 108 of CPM 102n may be connected to a broadband communication link, such as an OC-3 link. CPM 102n may process a portion of the data received from the broadband link and forward the remainder to CPM 102c via interfaces 106n and 104c. Assuming that CPM 102n is configured to process 25% of the traffic being monitored, 75% will be forwarded to downstream CPMs 102c-a to be processed. The remainder of the traffic stream between CPM 102n and 102c may be idle. Alternatively, as will be discussed in more detail below, the traffic stream between the cascadable processing modules may include simulated traffic to be transmitted to a device under test when platform 100 is being used to load and receive data from a broadband communication link.

CPM 102c receives the unprocessed traffic from CPM 102n and extracts a second predetermined portion (e.g., another 25%) for CPM 102c to process. CPM 102c replaces the processed traffic with idle traffic and forwards the remainder to CPM 102b. Thus, link 109 between CPMs 102c and 102b will be 50% traffic being monitored and 50% idle.

CPM 102b receives the unprocessed traffic from CPM 102c and extracts a third predetermined portion (e.g., another 25%) for CPM 102b to process, replaces the processed traffic with idle traffic, and forwards the remainder to CPM 102a. Thus, link 109 between CPMs 102b and 102a will be 25% traffic being monitored and 75% idle.

CPM 102a receives the unprocessed traffic from CPM 102b and extracts a fourth predetermined portion (e.g., another 25%) for CPM 102a. Since CPM 102a receives the last 25% of monitored data to be processed, all of the monitored data received over the broadband communication link has been processed. Thus, cascadable processing modules 102a-102n according to embodiments of the present invention are capable of distributing and processing data received from a broadband communication link without requiring the use of specialized processing circuitry dedicated to processing a high-speed link.

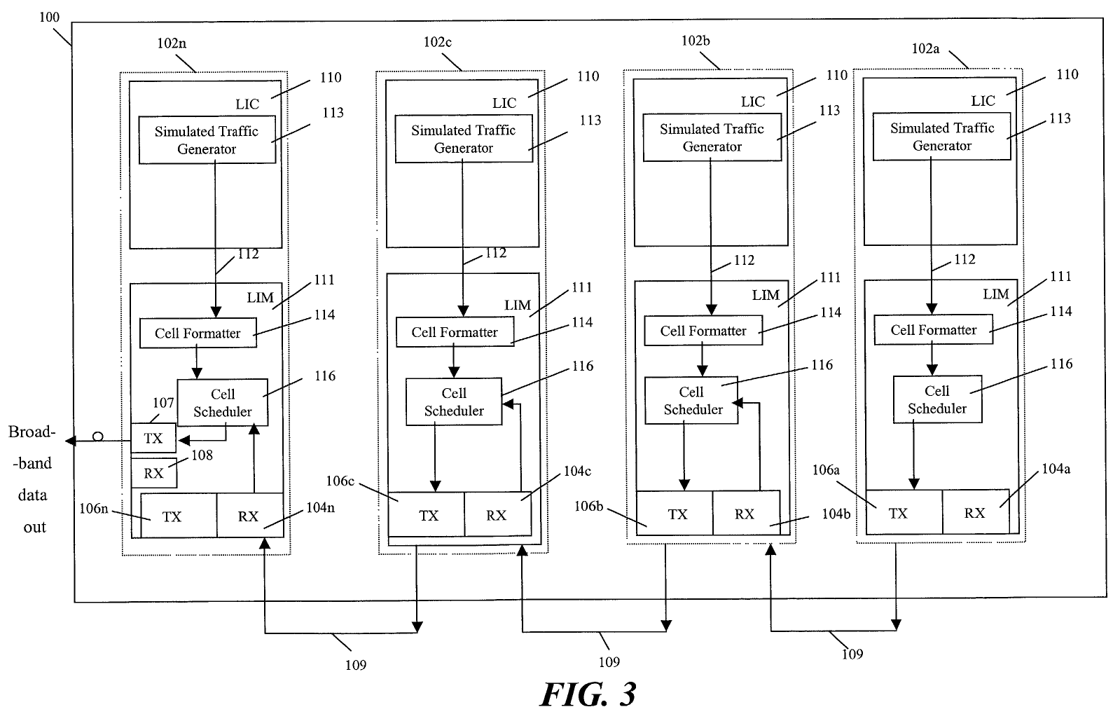

FIG. 3 is a block diagram of platform 100 illustrating in more detail the transmit functionality described with respect to FIG. 1. In FIG. 3, each cascadable processing module of platform 100 comprises a link interface controller (LIC) 110 and a link interface module (LIM) 111. LICs 110 and LIMs 111 may each be a printed circuit board with one or more processing units and associated memory. LICs 110 and LIMs 111 may communicate with each other via communications buses 112. In addition, a separate bus (not shown) may be used for inter-LIC message communication.

In the illustrated embodiment, LICs 110 each include simulated traffic generators 113 for generated simulated signaling and/or data traffic. Simulated traffic generators 113 may comprise software executing on the processing unit of each LIC 110. Simulated traffic generators 113 may generate a variety of traffic types, including SS7 signaling traffic for testing SS7 signaling points, IP traffic for testing IP nodes, and data traffic for testing circuits responsible for data channels between end users. Any type of simulated traffic that may be used to fill a broadband communication link is intended to be within the scope of the invention.

Each LIM 111 includes functionality for packaging the data traffic into a format suitable for filling the broadband communication channel. In the illustrated example, LIMs 111 fill the broadband channel with ATM cells. Cell formatters 114 of each LIM receive simulated traffic from simulated traffic generator 113 of an associated LIC 110, break the information into cells suitable for transmission over an ATM connection, and add headers to the ATM cells. The protocol implemented by cell formatters 114 may be ATM adaptation layer 2 or any other suitable ATM adaptation layer protocol.

According to an important aspect of the invention, each LIM 111 includes a cell scheduler 116 for detecting idle cells on its associated external receive interface and replacing a portion of the idle cells with simulated traffic cells received from cell formatter 114. For example, the external transmit interface 106a-106n of each LIM 111 may comprise a physical layer and framer chip that generates idle ATM cells over an appropriate physical layer protocol in the absence of traffic from cell schedulers 116. In one embodiment, external transmit interfaces 106a-106n may be configured to generate idle ATM cells over an electrical interface, such as a 155 Mbps category-5 unshielded twisted pair (UTP-5) or shielded twisted pair cable per the “ATM Forum—ATM Physical Medium Dependent Interface Specification for 155 Mbit/s over Twisted Pair Cable,” V1.0, September 1994. Broadband transmit interface 107 may be configured to generate idle ATM cells to be transmitted over an optical interface, such as an OC-n interface, where n is an integer representing any multiple of the base rate for OC transmission currently adopted or that may in the future be adopted by a telecommunications standards organization, such as ANSI, ITU, ETSI, or others. Cell schedulers 116 detect idle cells received from downstream LIMs and replace the idle cells with simulated traffic cells. The number of idle cells replaced by each cell scheduler 116 depends on the bandwidth allocated to each LIM. Exemplary bandwidth allocation algorithms for filling the broadband connection will now be discussed in more detail.

In one exemplary test case, each LIM may manage a number of VPI/VCI connections between platform 100 and a device under test, such as an SS7 node using ATM as the underlying transport mechanism for SS7 messages. In order to manage such connections, each LIM may have a transmit schedule table generated by cell schedulers 116. Cell schedulers 116 may give each open connection (VPI/VCI) at least one entry in a transmit schedule table. Cell schedulers 116 may use the table to allocate bandwidth. Each entry in the table may correspond to a time slot allocated to a particular VCI/VPI connection. If bandwidth is allocated equally among VCI/VPI connections, each open VCI/VPI connection would have an equal number of entries in the transmit schedule table. If bandwidth is not equally allocated among VPI/VCI connections, at least some of the VPI/VCI connections would have unequal numbers of entries in the transmit schedule table.

In order to allocate bandwidth among VPI/VCI connections on a single LIM, a cell scheduler 116 traverses each entry in its transmit schedule table. In response to detecting the presence of an entry for a connection, the cell scheduler determines if a particular VPI/VCI connection has a cell ready for transmission. If a cell is available for that connection it is transmitted, provided that idle cells are present in the datastream received from an upstream LIM at that particular time period. Methods for allocating bandwidth among different LIMs will be discussed in more detail below. If a cell is not available, or after the first cell is transmitted, the next entry in the table is checked. The next entry may be for the same VPI/VCI connection and hence cell scheduler 116 may determine whether another cell is ready to be transmitted for that connection. The process is repeated until all entries in the table have been traversed. Then, the cell scheduler may return to the first entry in the table and restart the scheduling process.

By properly building the transmit schedule table, available bandwidth can be distributed among the open connections in any fashion that is desired. For example, assuming 11 open connections, if one connection has 10 entries and the other 10 each have a single entry, one connection gets up to 50% of available cell bandwidth and the others each get 5%.

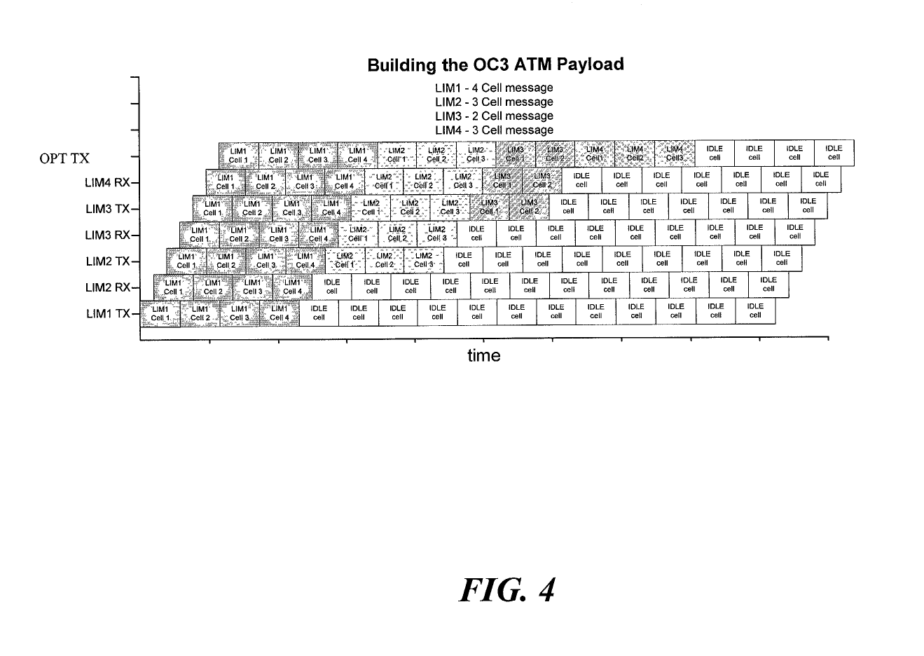

FIG. 4 is a timing diagram illustrating an exemplary mechanism for allocating bandwidth among LIMs in order to fill a broadband link with simulated signaling traffic according to an embodiment of the present invention. The timing diagram assumes 4 LIMs share the available bandwidth. The entries along the vertical axis represent the transmit and receive interfaces of each LIM. In FIG. 4, the LIMs are labeled LIM1-LIM4, where LIM1 is the first LIM in the transmission chain and LIM4 is the last LIM in the chain. LIM4 is assumed to be connected to the high-speed link that is desired to be filled. In this example, it is assumed that LIM1 has a four-cell message to send, LIM2 has a three-cell message to send, LIM3 has a two-cell message to send, and LIM4 has a three-cell message to send.

Beginning with the LIM1 TX interface, LIM1 may have a completely open transmission link to fill because there may only be idle cells present in the link initially. Alternatively, if cells are being received from a device under test, the simulated traffic generated by LIM1 may have to compete with the received cells for bandwidth on LIM1's TX channel. The use of a LIM for both transmitting and receiving data will be discussed in more detail below. In the example illustrated in FIG. 4, it is assumed that no cells have been received from a device being tested or monitored and hence LIM1 initially has an open channel.

Since LIM1 is the first module in the chain of cascadable processing modules, LIM1 can “hog” the link and keep any downstream LIMs from seeing any idle cells. If LIM1 can consistently fill the link, there is no need for downstream LIMs to transmit because LIM1 can completely load the high-speed link with simulated traffic. Thus, one potential method for allocating transmit bandwidth among LIMs is to allow each LIM to transmit as many cells as that LIM has available before allowing the next LIM to transmit.

Another potential bandwidth allocation algorithm is to allow each LIM to periodically transmit as many cells as that LIM has available to transmit. If LIM1 periodically hogs the link, the downstream LIMs have to wait until idle cells are present in the traffic stream, which may be the next frame of the underlying physical layer protocol or longer. These messages that are waiting to be transmitted may be held in buffers in the LIC's memory and transferred into the LIM's memory when the memory of the particular LIM has room for the messages. Thus, if a LIM 111 is unable to get a turn (via idle cell detection) to dump its cells into the stream, the LIM will throttle all the way back to the LIC's transmit message buffer memory. This scheme has no per LIM bandwidth allocation and software will have to check message transmit latency to manage traffic flow.

The bandwidth allocation algorithm illustrated in FIG. 4 allows each LIM to transmit all available cells at the expense of downstream LIMs. The LIM1 TX interface inserts its four cells into the traffic stream followed by idle cells. These four cells are received by the LIM2 RX interface. Cell scheduler 116 associated with LIM2 detects these cells and waits for an idle cell. When an idle cell is detected, LIM2 inserts its two cells that are waiting to be transmitted into the traffic stream, followed by idle cells. LIM3's RX interface receives the four cells transmitted by LIM1, and the two cells transmitted by LIM2. When LIM3 detects an idle cell, LIM3 inserts its three waiting cells into the traffic stream, followed by idle cells. LIM4's RX interface receives the cells transmitted by the upstream LIMs and inserts its 3 cells into the traffic stream in response to detecting the first idle cell. The OC-3 TX interface is completely filled with simulated traffic for a predetermined time interval. In order to completely load an OC-3 link, the combination of LIMs must generate enough cells to fill an OC-3 frame every 125 microseconds. There are 2340 octets in one OC-3 frame. An ATM cell has 53 octets. Hence, the combination of LIMs must generate 44.1 cells every 125 microseconds to fill an OC-3 frame. This can be accomplished using the bandwidth allocation algorithm described with respect to FIG. 4.

Another possible bandwidth allocation algorithm is for each cell scheduler 116 to be programmed in advance with a percentage of the transmission link that has been allocated to the particular LIM (e.g., 25%). The LIM will fill the ATM stream with no more than its percentage. Assuming at time=0, that each LIM has the following number of cells to transmit:

LIM1 TX 2 Cells

LIM2 TX 5 Cells

LIM3 TX 4 Cells

LIM4 TX 2 Cells

In this case the LIM transmits a cell if 1) it sees an idle cell AND 2) the LIM has “waited” the minimum number of cells (which would be three cells in the four LIM case where each LIM is allocated 25% of available cell bandwidth. This prevents overallocation of bandwidth to a single LIM at the expense of an unfilled link if the traffic distribution is not well maintained across the LIMs (e.g. LIM 1 is allocated bandwidth whether used or not). The following text is a timing diagram illustrating transmission by each LIM. Each number represents transmission of a cell by a particular LIM. For example, each ‘1’ indicates a cell transmission by LIM1 and each ‘2’ represents a cell transmission by LIM2, etc. Each ‘i’ represents transmission of an idle cell. Time is assumed to increase from left to right.

| LIM1 | 1iii | 1iii | iiii | iiii | iiii | iiii | iiii | iiii |
|---|---|---|---|---|---|---|---|---|
| LIM2 | 12ii | i2ii | i2ii | i2ii | i2ii | iiii | iiii | iiii |
| LIM3 | ii31 | ii3i | ii3i | ii3i | iiii | iiii | iiii | iiii |
| LIM4 | iii4 | iii4 | iiii | iiii | iiii | iiii | iiii | iiii |
| OC-3 | 1234 | 1234 | i23i | i23i | i2ii | iiii | iiii | iiii |

In this example, LIM1 transmits its first cell during the first time slot, waits three time slots, then transmits its next cell. LIM2 transmits its three cells second, sixth, tenth, and fourteenth time slots. LIMs 3 and 4 follow similar routines to transmit their available cells. The resulting data stream at the output of LIM4 is labeled ‘OC-3’, since using this bandwidth algorithm, data from a group of LIMs may be used to fill an OC-3 link. However, as illustrated in the OC-3 line, the OC-3 link is not completely filled. This is because some of the LIMs did not have cells available to transmit when their timeslot became available.

To avoid this problem of partial filling of an OC-3 link, a hybrid bandwidth allocation algorithm may be used where the LIMs are over allocated bandwidth (e.g., 33% for a 4 LIM system). This limited overallocation may require some buffering at the LIMs but reduces the likelihood of incomplete filling of the high-speed link.

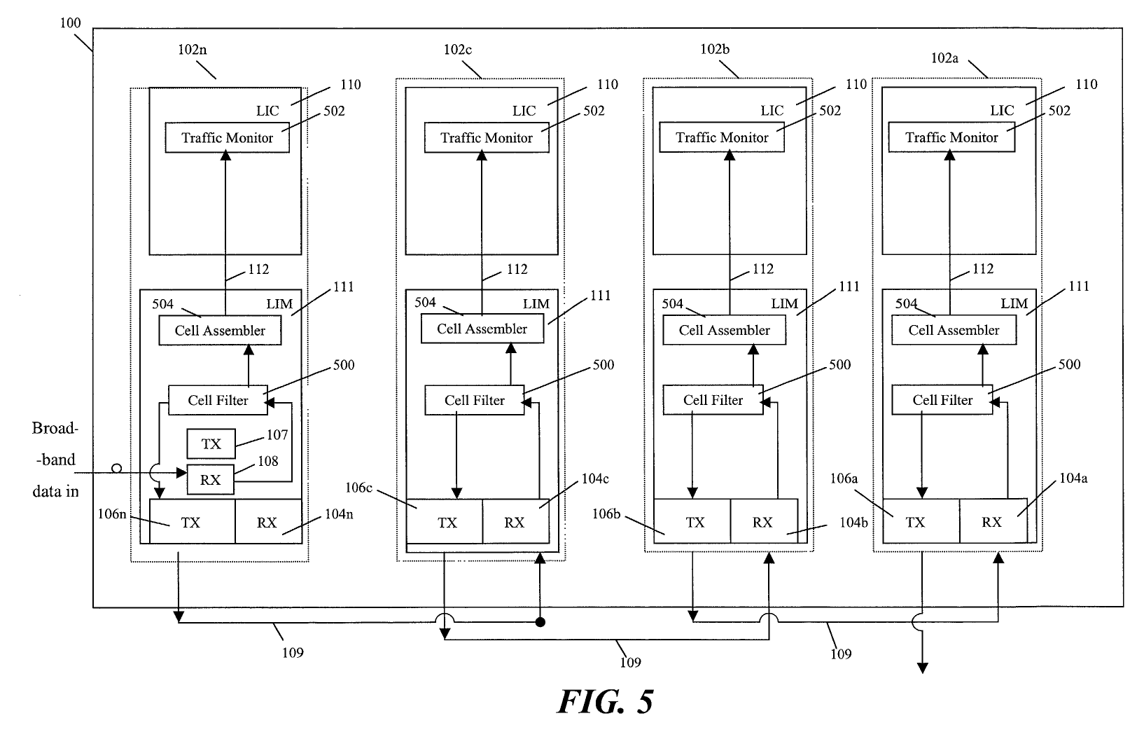

FIG. 5 is a functional block diagram illustrating in detail the broadband receive functionality described above with respect to FIG. 2. In FIG. 5, each LIM includes a cell filter 500 for filtering cells received via its receive interface. Cell filters 500 preferably filter incoming cells at each LIM to distribute the processing of data received via a broadband communication link to traffic monitoring applications 502 present on each LIC 110. Traffic monitoring applications 502 may be software configured to monitor any type of traffic, including SS7 traffic, IP traffic, etc. Exemplary functions that may be performed by traffic monitors 502 include CDR generation, peg counting, billing, billing verification, etc. Each LIM 111 also includes a cell assembler 504 to assemble cells received over the broadband link into messages recognizable by traffic monitors 502.

For ATM cells, each filter 500 may be configured to check whether received ATM cells have a VPI/VCI that falls with in a particular range of VPI/VCI values. If the VPI/VCI falls within the predetermined range, then the cell is passed to the traffic monitor 502 associated with the particular receiving LIM. If the VPI/VCI is not within the particular range, then the cell is passed to the transmit interface (TX) associated with the particular LIM.

In order to distribute the processing of incoming cells, each cell filter 500 is preferably configured to handle different ranges of VPI/VCI values. In the four LIM system illustrated in FIG. 5, each LIM 111 may be configured to monitor 25% of the incoming traffic. Accordingly, filter 500 associated with the LIM that receives the broadband data from an external node may be programmed to pass 25% of the incoming traffic to its traffic monitor 502 and pass the remainder of the incoming cells to the next downstream LIM. The next LIM may be programmed to process a second range of VPI/VCIs that differs from the first range and pass the remainder. This process continues with each LIM until all of the traffic is passed to a traffic monitor 502. By dividing the processing responsibility among multiple processors, conventional network monitoring devices can monitor high-speed communication links without requiring specialized high-speed processors.

### LIM Hardware

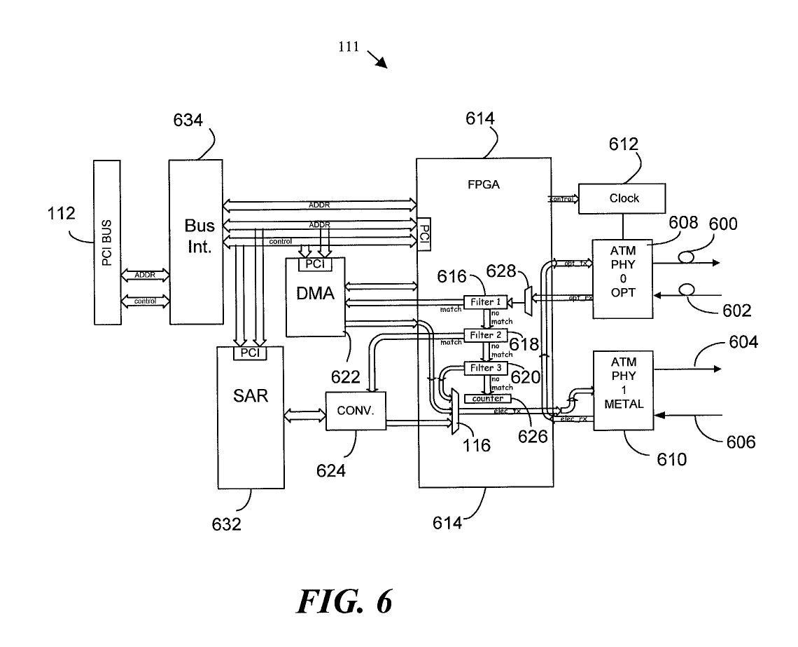

FIG. 6 is a block diagram illustrating exemplary LIM hardware suitable for use with embodiments of the present invention. In the illustrated embodiment, LIM 111 includes optical transmit and receive interfaces 600 and 602 and electrical transmit and receive interfaces 604 and 606. Optical transmit and receive interfaces correspond to external broadband communication interfaces 107 and 108 described with respect to FIGS. 1-5. Similarly, external electrical transmit and receive interfaces 604 and 606 correspond to any of the remaining external transmit and receive interfaces described with respect to FIGS. 1-5. Physical and ATM layer functions for the transmit and receive interfaces are handled by physical and ATM layer chips 608 and 610. For example, chip 608 may be an ATM over SONET chip capable of sending and receiving ATM data over a SONET network. Transmit and receive clock 612 may supply transmit and receive clock signals to chip 608 for synchronous transmission and reception over the SONET network. Chip 610 may be an ATM over 155 Mbps twisted pair chip for sending ATM cells over an electrical interface, such as a twisted pair interface. An exemplary commercially available PHY chip suitable for use as chips 608 and 610 is the 77155 UNI PHY device available from IDT Corporation.

FPGA 614 may be programmed to perform the above-mentioned cell scheduling and idle cell detection functions described above with regard to transmitting simulated signaling or data traffic over a high speed communication link. FPGA 614 may also be programmed to perform the above-mentioned filtering functions associated with receiving traffic to be monitored from a high-speed communication link. In the illustrated embodiment, FPGA 614 includes three filters 616, 618, and 620 programmed to filter based on different ranges of VPI/VCI combinations. Filter 616 directs cells that match its criteria to DMA chip 622 for transmission to memory of an associated LIC. Filter 618 directs cells that match its criteria to converter chip 624 for conversion from an ATM adaptation layer protocol to a propriety protocol, such as the Intel IX protocol. Filter 620 directs cells that match its filter criteria to electrical transmission interface 604 for transmission to another LIM. A counter 626 counts the number of cells that do not match any of the VPI/VCI ranges. A multiplexer 628 multiplexes traffic received over optical receive interface 602 or electrical receive interface 604 into a common traffic stream for processing by filters 616, 618, and 620. Finally, cell scheduler 116 described above may be implemented as a state machine that looks for cells to transmit in an outbound data stream using one of the above-described bandwidth allocation algorithms. An example of a commercially available device suitable for use as FPGA 614 is any of the FPGAs available from Altera Corporation, such as the EP1K100.

As stated above, DMA chip 622 writes messages received by LIM 111 to an associated LIC and reads messages from LIC memory to FPGA 614 for outbound transmission. An exemplary commercially available chip suitable for use as DMA chip 622 is the NicSTar™ available from IDT Corporation. Converter 624 converts between ATM format and a proprietary format recognizable by a SAR chip 632. An exemplary commercially available chip suitable for use as converter 624 is the Rosetta IX to Utopia core available from Intel for implementation in a Xilinx Corporation FPGA. Bus interface chip 634 provides an interface to bus 112, which in a preferred embodiment is a PCI bus. Using a PCI bus allows chips 622 and 632 to directly access LIC memory using DMA transfers. An exemplary commercially available chip suitable for use as bus interface chip 634 is the 21544 Bridge available from Intel Corporation. Finally, segmentation and reassembly (SAR) chip 632 puts messages received from a LIC into cell format and assembles cells received from the network into packet format for processing by monitoring applications associated with the LIC. An exemplary commercially available network processor chip that may be programmed to perform segmentation and reassembly functions of SAR 632 is the IXP 1200 available from Intel Corporation. Each of the chips illustrated in FIG. 6 may include internal or external memory devices (not shown) for buffering cells or other protocol data units received from other chips.

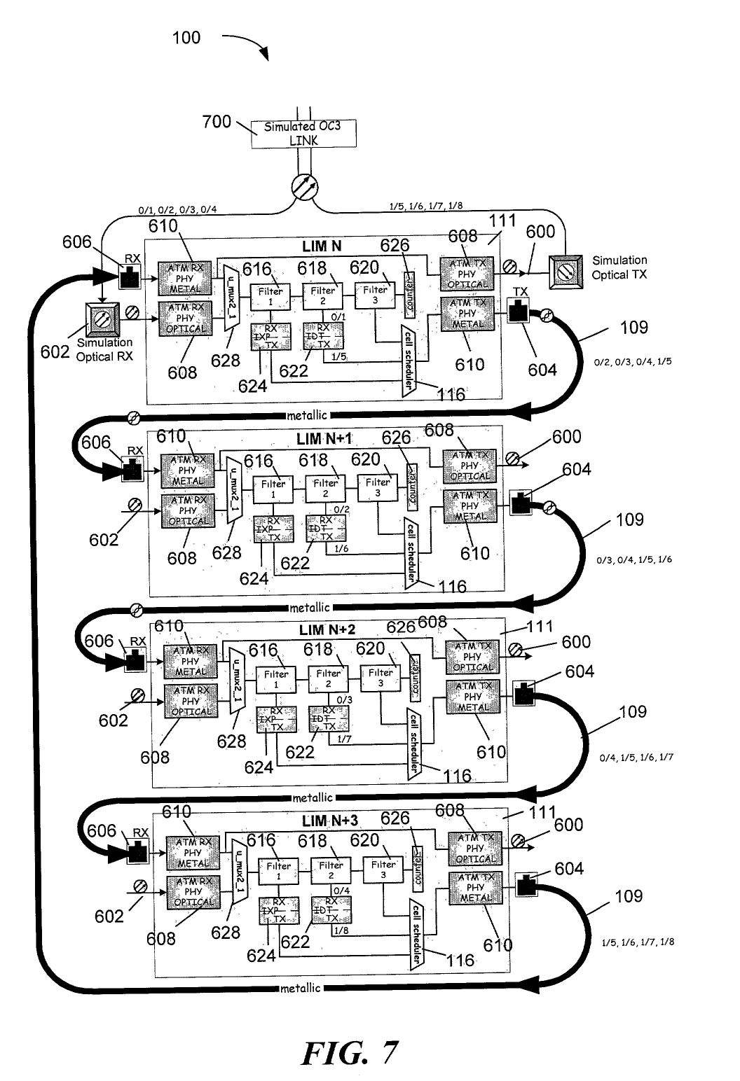

FIG. 7 illustrates an example of a platform 100 that is capable of both loading a broadband communication link with simulated traffic and receiving traffic from a broadband communication link. In FIG. 7, each LIM includes the same hardware components described with respect to FIG. 6. Hence, a detailed description thereof will not be repeated herein. In FIG. 7, each LIM includes optical physical layer chips 608 for sending and receiving ATM cells over an optical interface and electrical physical layer chips 610 for sending and receiving ATM cells over an electrical interface. In the illustrated example, chips 608 are 610 are shown as performing either transmit only or receive only functions. It is understood that a single chip may perform both transmit and receive functions.

LIMs 111 illustrated in FIG. 7 are respectfully labeled LIM N−N+3. LIMs N−N+3 are connected in series by links 109, which may be twisted pair links or an internal serial links, as discussed above. More particularly, electrical transmit interfaces 604 of LIMs N−N+2 are connected to electrical receive interfaces 606 of LIMs N+1−N+3. Electrical transmit interface 604 of LIM N+3 is connected to electrical receive interface 606 of LIM N. Finally, optical transmit interface 600 and optical receive interface of 602 of LIM N are connected to broadband communication link 700. In this configuration, platform 100 is capable of both sending simulated traffic to and receiving traffic from a device under test, such as an ATM switch or an SS7 SP, over a broadband communication link.

An example of the operation of platform 100 when simultaneously sending simulated traffic to and receiving traffic from broadband communication link 700 will now be discussed in detail. In this example, it is assumed that ATM cells received from broadband communication link 700 will have VPI/VCIs of 0/1, 0/2, 0/3, and 0/4. Simulated traffic transmitted over broadband communication link 700 will have VPI/VCIs of 1/5, 1/6, 1/7, and 1/8. It is also assumed that filters 618 of each LIM are configured to filter received ATM cells having a particular VPI/VCI combination for further processing by an associated LIC and that filters 616 and 620 of each LIM are configured to pass all cells. More particularly, filter 618 of LIM N is configured to filter cells having a VPI/VCI combination of 0/1, filter 618 of LIM N+1 is configured to filter cells having a VPI/VCI combination of 0/2, filter 618 of LIM N+2 is configured to filter cells having a VPI/VCI combination of 0/3 and filter 618 of LIM N+3 is configured to filter cells having a VPI/VCI combination of 0/4. LIM N is configured to transmit simulated cells having a VPI/VCI combination of 1/5, LIM N+1 is configured to transmit simulated cells having a VPI/VCI combination of 1/6, LIM N+2 is configured to transmit simulated cells having a VPI/VCI combination of 1/7 and LIM N+3 is configured to transmit simulated cells having a VPI/VCI combination of 1/8.

Both ATM cells to be transmitted onto broadband communication link 700 and ATM cells received from broadband communication link 700 pass through the filters. The cells to be transmitted are passed, while each LIM is configured to filter a predetermined portion of the received cells. This filter configuration allows simulated traffic to be transmitted to follow essentially the same path through platform 100.

In operation, optical receive interface 602 of LIM N receives cells with VPI/VCI combinations of 0/1, 0/2, 0/3, and 0/4 from a device under test. These cells pass through optical physical layer receive chip 608, multiplexer 628, and filter 616. Filter 616 passes the received traffic to filter 618. Filter 618 removes cells having a VPI/VCI combination of 0/1 for further processing by an associated LIC (not shown). The remaining received cells are passed to cell scheduler 116. DMA chip 622 transmits simulated cells generated by an associated LIC having a VPI/VCI combination of 1/5 to cell scheduler 116. Cell scheduler 116 waits for an open cell time slot and inserts the received cells having VPI/VCI combinations of 0/2, 0/3, and 0/4 followed by the simulated cells having a VPI/VCI combination 1/5 into the traffic stream to be sent to LIM N+1.

LIM N+1 receives the traffic from LIM N, filters the received cells having a VPI/VCI combination of 0/2, and inserts simulated cells having a VPI/VCI combination of 1/6 into the traffic stream to be sent to LIM N+2. Thus, the cells on serial link 109 between LIMs N+1 and N+2 have VPI/VCI combinations of 0/3, 0/4, 1/5, and 1/6.

LIM N+2 receives the traffic from LIM N+1, filters the received cells having a VPI/VCI combination of 0/3 and inserts simulated cells having a VPI/VCI combination of 1/7 into the traffic stream to be sent to LIM N+3. Thus, the cells on serial link 109 between LIMs N+2 and N+3 have VPI/VCI combinations of 0/4, 1/5, 1/6, and 1/7.

LIM N+3 receives the traffic from LIM N+2, filters the received cells having a VPI/VCI combination of 0/4 and inserts simulated cells having a VPI/VCI combination of 1/8 into the traffic stream to be sent to LIM N. Thus, the cells on serial link between LIMs N+3 and N have VPI/VCI combinations of 1/5, 1/6, 1/7, and 1/8. LIM N receives the simulated traffic having VPI combinations of 1/5, 1/6, 1/7, and 1/8. This traffic is sent from electrical receive interface 606 of LIM N to optical transmit interface 600 of LIM N and onto broadband communication link 700. Thus, platform 100 illustrated in FIG. 7 is capable of simultaneously sending simulated traffic to and receiving traffic from a broadband communication link. Such a feature is extremely useful when testing a device, such as an SS7 SP with an ATM interface or an ATM switch, because the communication link to the device under test can be loaded and the response can be monitored using a single platform.

Because platform 100 divides the responsibility of filling a broadband communication link among multiple communication processors, the need for specialized high-speed processors for LICs 110 is reduced. For example, each LIC 110 may include a general-purpose microprocessor, such as an AMD K6 processor or an Intel x86 processor for performing traffic simulation or network monitoring applications. As a result, the overall cost of a network monitoring and traffic generation system incorporating such processors is reduced. In addition, the same network monitoring and traffic generation system incorporating a plurality of cascadable processing modules can be used for testing both low speed links, such as conventional SS7 signaling links, and high speed links, such as OC-n links.

It will be understood that various details of the invention may be changed without departing from the scope of the invention. Furthermore, the foregoing description is for the purpose of illustration only, and not for the purpose of limitation—the invention being defined by the claims.

What is claimed is:

1. A method for loading a broadband communication link with simulated signaling or data traffic using a plurality of cascadable processing modules, the method comprising:
at a first cascadable processing module:
(a) generating first simulated signaling or data traffic and transmitting the simulated signaling or data traffic over a serial communication link;
(b) generating idle traffic and transmitting the first idle traffic over the serial communication link after transmitting the first simulated signaling or data traffic;
at a second cascadable processing module:
(c) generating second simulated signaling or data traffic;
(d) receiving the first simulated signaling traffic and the first idle traffic from the serial communication link,
(e) in response to detecting the first idle traffic, replacing at least some of the first idle traffic with the second simulated signaling or data traffic; and
(f) transmitting the first and second simulated signaling or data traffic over a broadband communication link.

2. The method of claim 1 wherein generating the first and second simulated signaling or data traffic includes generating simulated SS7 signaling traffic.

3. The method of claim 1 wherein generating the first and second simulated signaling or data traffic includes generating simulated IP signaling or data traffic.

4. The method of claim 1 wherein generating the first and second simulated signaling or data traffic includes generating simulated packetized voice traffic.

5. The method of claim 1 wherein generating the first idle traffic includes generating idle asynchronous transfer mode (ATM) cells.

6. The method of claim 1 wherein transmitting the first simulated signaling or data traffic and the first idle traffic over a serial communication link includes transmitting the first simulated signaling or data traffic through a physical connector connecting an external transmit interface of the first cascadable processing module to an external receive interface of the second cascadable processing module.

7. The method of claim 1 wherein transmitting the first simulated signaling or data traffic and the first idle traffic over a serial communication link includes transmitting the first simulated signaling or data traffic over a serial communication link located inside of a traffic simulation device shelf that includes the first and second cascadable processing modules.

8. The method of claim 1 wherein generating the second simulated signaling or data traffic includes generating the second simulated signaling or data traffic during a time period that overlaps with generating the first simulated signaling or data traffic.

9. The method of claim 1 wherein transmitting the first and second simulated signaling or data traffic over the broadband communication link includes transmitting the first an second simulated signaling or data traffic over an optical communication link.

10. The method of claim 9 wherein the optical communication link comprises a SONET communication link.

11. The method of claim 10 wherein the SONET communication link comprises an OC-n communication link, n being an integer indicative of a multiple of a base signaling rate.

12. The method of claim 11 wherein n is equal to at least three.

13. The method of claim 9 wherein the optical communication link comprises a synchronous digital hierarchy (SDH) communication link.

14. The method of claim 1 further comprising, at the first cascadable processing module, executing a predetermined bandwidth allocation algorithm to determine how much signaling or data traffic to send to the second cascadable processing module and, at the second cascadable processing module, executing the predetermined bandwidth allocation algorithm to determine how much signaling or data traffic to transmit over the broadband communication link.

15. The method of claim 14 wherein executing a predetermined bandwidth allocation algorithm includes transmitting all available signaling or data traffic.

16. The method of claim 14 wherein executing a predetermined bandwidth allocation algorithm includes periodically transmitting all available signaling or data traffic.

17. The method of claim 16 wherein periodically transmitting all available signaling or data traffic includes overallocating periodic transmission times to the first and second cascadable processing modules.

18. A method for receiving data from a device under test transmitted over a broadband communication link using a plurality of cascadable processing modules, the method comprising:
at a first cascadable processing module:
(a) receiving data over a broadband communication link from a device under test;
(b) filtering the data to extract a first portion from the data;
(c) forwarding the first portion to a first monitoring application for further processing; and
(d) transmitting the remainder of the data over a serial communication link;
at a second cascadable processing module:
(e) receiving the remainder of the data from the first cascadable processing module;
(f) filtering the remainder of the data to extract a second portion from the remainder of the data;
(g) transmitting the second portion to a second monitoring application for further processing; and
(h) forwarding any remaining data over the serial communication link.

19. The method of claim 18 wherein receiving data over a broadband communication link comprises receiving data over an optical communication link.

20. The method of claim 19 wherein receiving data over an optical communication link comprises receiving data from a SONET network.

21. The method of claim 19 wherein receiving data from a SONET network comprises receiving data over an OC-n communication link where n is an integer indicative of a multiple of a base signaling rate.

22. The method of claim 21 wherein n is equal to at least three.

23. The method of claim 19 wherein receiving data over an optical communication link includes receiving data from a synchronous digital hierarchy (SDH) network.

24. The method of claim 18 wherein receiving data over a broadband communication link comprises receiving ATM cells transmitted over the broadband communication link and wherein filtering the data includes filtering the data based on at least one of a virtual path identifier and a virtual channel identifier in the ATM cells.

25. The method of claim 24 wherein filtering the data at the first cascadable processing module comprises filtering the data based on a first range of VPI/VCI values and wherein filtering the data at the second cascadable processing module comprises filtering the data based on a second range of VPI/VCI values that differs from the first range.

26. The method of claim 18 wherein forwarding the first and second data portions to first and second monitoring applications includes forwarding the first and second data portions to first and second usage and measurements applications.

27. The method of claim 18 wherein forwarding the first and second data portions to the first and second monitoring application includes forwarding the first and second data portions to first and second billing applications.

28. The method of claim 18 wherein forwarding the first and second data portions to first and second monitoring applications includes forwarding the first and second data portions to a first and second call detail record generation applications.

29. A method for testing a device over a broadband communication link, the method comprising:
(a) connecting a plurality of cascadable processing modules using serial communication links;
(b) simultaneous generating, at each of the cascadable processing modules, simulated traffic to be sent to a device under test;
(c) transmitting the simulated traffic between the cascadable processing modules;
(d) at each of the cascadable processing modules, aggregating simulated traffic received from upstream cascadable processing modules with simulated traffic generated by each cascadable processing module and forwarding the aggregated traffic to downstream processing modules over the serial communication links; and
(e) transmitting the aggregated simulated traffic generated by all of the cascadable processing modules to a device under test over a broadband communication link.

30. The method of claim 29 comprising:
(a) receiving monitored traffic from the device under test;
(b) transmitting the monitored traffic between the cascadable processing modules via the serial communication links; and
(c) at each cascadable processing module, filtering a predetermined portion of the monitored traffic for further processing.

31. The method of claim 30 wherein receiving monitored traffic from the device under test includes receiving monitored traffic from the device under test simultaneously with sending the simulated traffic to the device under test.

32. The method of claim 29 wherein the device under test comprises an SS7 signaling point (SP).

33. The method of claim 29 wherein the device under test comprises an asynchronous transfer mode (ATM) switch.

34. The method of claim 29 wherein transmitting the simulated traffic over the broadband communication link comprises transmitting the simulated traffic over an optical communication link.

35. The method of claim 34 wherein transmitting the simulated traffic over an optical communication link includes transmitting the simulated traffic over an OC-n communication link, n being an integer.

36. The method of claim 35 wherein n is equal to at least three.

37. The method of claim 34 wherein transmitting the simulated traffic over an optical communication link includes transmitting the simulated traffic over a synchronous digital hierarchy (SDH) communication link.

38. A platform for testing a device over a broadband communication link, the platform comprising:
(a) a first cascadable processing module for generating a first simulated traffic portion followed by a first idle traffic portion;
(b) a second cascadable processing module for receiving the first simulated traffic portion and the idle traffic portion from the first cascadable processing module, replacing the first idle traffic portion with a second simulated traffic portion, and for transmitting the first and second simulated traffic portions over a broadband communication link; and
(c) a serial communication link for connecting the first and second cascadable processing modules.

39. The platform of claim 38 wherein the first and second cascadable processing modules each include an external transmit interface and an external receive interface and wherein the serial communication link comprises a physical connection between the external transmit interface of the first cascadable processing module and the external receive interface of the second cascadable processing module.

40. The platform of claim 38 comprising a housing, wherein the serial communication link comprises a connection located inside the housing.

41. The platform of claim 38 wherein each of the first and second cascadable processing modules comprises:
(a) a link interface module (LIM) for sending and receiving traffic over external communication links; and
(b) a link interface controller (LIC) coupled to the LIM for generating the first and second simulated traffic portions and for processing traffic received by the first and second cascadable processing modules.

42. The platform of claim 41 wherein the link interface module associated with the first cascadable processing module is adapted to receive data from a broadband communication link.

43. The platform of claim 42 wherein the broadband communication link comprises an optical communication link.

44. The platform of claim 43 wherein the optical communication link comprises a SONET communication link.

45. The platform of claim 44 wherein the SONET communication link comprises an OC-n communication link, in being an integer indicative of a multiple of a base transmission rate.

46. The platform of claim 43 wherein the optical communication link comprises a synchronous digital hierarchy (SDH) communication link.

47. The platform of claim 41 wherein the second cascadable processing module is adapted to transmit the first and second simulated traffic portions over an optical communication link.

48. The platform of claim 47 wherein the optical communication link comprises a SONET communication link.

49. The platform of claim 48 wherein the SONET communication link comprises an OC-n communication link, n being an integer indicative of a multiple of a base transmission rate.

50. The platform of claim 48 wherein the optical communication link comprises a synchronous digital hierarchy (SDH) communication link.

51. The platform of claim 38 wherein the first cascadable processing module includes a cell scheduler for determining how much traffic to include in the first simulated traffic portion to be sent to the second cascadable processing module.

52. The platform of claim 51 wherein the cell scheduler executes a predetermined bandwidth allocation algorithm to determine how much traffic to include in the first idle traffic portion.

53. The platform of claim 52 wherein the predetermined traffic allocation algorithm includes transmitting all available traffic from the first cascadable processing module to the second cascadable processing module.

54. The platform of claim 52 wherein the predetermined bandwidth allocation algorithm includes periodically transmitting all available traffic from the first cascadable processing module to the second cascadable processing module.

55. A platform for processing data received from a device under test over a broadband communication link using a plurality of cascadable processing modules, the platform comprising:
(a) a first cascadable processing module for receiving data from a device under test over a broadband communication link and for filtering a first portion of the data for further processing and forwarding the remainder of the data;
(b) a network monitoring application associated with the first cascadable processing module for receiving the first portion of the data and processing the first portion of the data;
(c) a second cascadable processing module for receiving the remainder of the data from the first cascadable processing module, filtering the remainder, extracting a second portion of the data for further processing, and forwarding any remaining data; and
(d) a second network monitoring application associated with the second cascadable processing module for processing the second portion of the data.

56. The platform of claim 55 wherein the external receive interface of the first cascadable processing module comprises an optical interface.

57. The platform of claim 56 wherein the optical interface comprises a synchronous optical network (SONET) interface.

58. The platform of claim 57 wherein the SONET interface comprises an OC-n interface, n being an integer indicative of a multiple of a base transmission rate.

59. The platform of claim 58 wherein n is equal to at least three.

60. The platform of claim 56 wherein the optical interface comprises a synchronous digital hierarchy (SDH) interface.

61. The platform of claim 55 wherein the first and second network monitoring applications comprise usage and measurement applications.

62. The platform of claim 55 wherein the first and second network monitoring applications comprise CDR generation applications.

63. The platform of claim 55 wherein the first and second network monitoring applications comprise billing applications.

64. A platform for testing a device over a broadband communication link, the platform comprising:
(a) a plurality of cascadable processing modules for generating simulated traffic to be sent to a device under test over a broadband communication link and for processing monitored traffic received from the device under test over the broadband communication link; and
(b) a plurality of serial communication links for connecting the cascadable processing modules in series and for communicating the simulated traffic to be sent to the device under test and the monitored traffic received from the device under test between the cascadable processing modules.

65. The platform of claim 64 wherein each of the cascadable processing modules includes at least one filter for filtering a portion of the traffic received from the device under test and for passing the remainder of the traffic received from the device under test to a downstream cascadable processing module.

66. The platform of claim 65 wherein each of the filters is adapted to receive and pass all of simulated signaling traffic generated by the platform.

67. The platform of claim 65 wherein each of the filters comprises a VPI/VCI filter.

68. The platform of claim 64 wherein each of the serial communication link comprises an electrical communication link.

69. The platform of claim 64 wherein each of the electrical communication links comprises a twisted pair communication link.

70. The platform of claim 64 wherein each of the serial communication links comprises an optical communication link.

71. The platform of claim 64 wherein the broadband communication link comprises a synchronous digital hierarchy (SDH) communication link.

72. The platform of claim 64 wherein the broadband communication link comprises an OC-n communication link, n being an integer of at least three.
